(19) United States
(12) Patent Application Publication
(10) Pub. No.: US 2018/0206483 A1
(43) Pub. Date: Jul. 26, 2018

(54) USE OF POLYMERS FOR THE PRODUCTION OF A RODENTICIDAL PRODUCT, RODENTICIDAL PRODUCT AND PROCESS FOR THE PRODUCTION THEREOF

(71) Applicants: Bernard SILLION, Lyon (FR); Jean-Michel VERD, Saint Chamond (FR); Bertrand BERGUE, Caluire et Cuire (FR); EXPERTO LIFE SCIENCES SARL, Luxembourg (LU)

(72) Inventors: Bernard SILLION, Lyon (FR); Jean-Michel VERD, Saint Chamond (FR); Bertrand BERGUE, Caluire et Cuire (FR); Romain LASSEUR, Bully (FR)

(21) Appl. No.: 15/744,900

(22) PCT Filed: Jul. 12, 2016
(86) PCT No.: PCT/EP2016/066545

§ 371 Date: Jan. 15, 2018

(30) Foreign Application Priority Data
Jul. 15, 2015 (FR) 1556668

(51) Int. Cl. A01N 25/00; A01N 37/02

(52) U.S. Cl. CPC A01N 25/004; A01N 37/02

(57) ABSTRACT

The invention consists of the use of hydrophilic polymers or copolymers of the polyacrylic acid or sodium polyacrylate family, which are crosslinked, in proportions of between 50 and 10 000 parts per million, for the production of a rodenticidal product. The rodenticidal product is composed of polymers or copolymers as mentioned above and of an appetizing coating according to respective proportions of from 1% to 50% by weight for the polymer and from 99% to 50% by weight for the appetizing composition. The process comprises the steps consisting in mixing the abovementioned polymers or copolymers with an appetizing product so as to form a paste, then in using an extruder to form the product.

The present invention relates to the use of polymers or copolymers for the manufacture of a rodenticidal product, to the rodenticidal product thus manufactured and to a process for the manufacture of this product.

Rodents may represent a health danger, as a result of the various diseases of which they may be the vector, but also an economic danger, since they are responsible for significant destruction of foodstuffs or significant damage to equipment, for example by gnawing cables.

The overpopulation of these rodents is such a problem that the worldwide rodenticide industry represents €400 000 000 to €600 000 000 (manufacturing value) in 2014 with a distribution of 34% for North America, 20% for Asia, 11% for Latin America and 35% for Europe, including approximately 11% for France.

The rodenticides currently on the market all use an active substance, the lethal effect of which is due to a chemical molecule which leads to various biological disturbances: either with an anti-vitamin K action for first-generation hydroxycoumarins (warfarin, coumachlor, coumatetralyl) or more toxic second-generation hydroxycoumarins (bromadiolone, difenacoum, difethialone, brodifacoum, flocoumafen, and the like) or also indanedione derivatives (chlorophacinone, diphacinone, and the like) or with an action on the central nervous system for chloraloses or crimidine or with a cardiotoxic and convulsant action, such as scilliroside. A hypercalcemia with calciferol or convulsions before respiratory arrest with strychnine have also been pursued.

In a known way, the rodenticide is composed of an edible appetizing product mixed with active products, such as those mentioned above.

However, these products are all dangerous to all animals but also to man, and pollute the environment. The European Commission is tireless in strengthening the requirements for the marketing of biocidal substances: Directive 98/8/EC has been replaced by Regulation No. 528/2012; the enforceable decision of the Commission of 17 Dec. 2013 limits the use of bromadiolone derivatives to professionals and a new classification of anti-vitamin K compounds by the ECHA has been carried out.

The fact of having available more ecological rodenticides has thus become a social need.

A rodenticidal product is an active substance or a preparation having the property of killing rodents. Mention may be made, among rodents, in particular harmful rodents, of rats (black rats, brown rats, for example), mice and also voles.

Several patent applications relating to rodenticides devoid of chemical agents registered in Annex 1 of the Biocidal Products Regulation 528/2012 have been filed.

European Patent Application No. EP 0 248 929 claims, for example, a rodenticidal product, the active principle of which is a plant product (vegetable or fruit) dehydrated under cold conditions and presented in the form of granules. This patent of 1986 discloses the fact that a rodenticidal effect may be obtained by a product having a hydrophilic nature but this matrix is combined with an active chemical principle which does not make it possible to assign a rodenticidal activity to the hydrophilic plant product.

On the basis of this same concept, the Japanese patent application No. JPH 02304007 describes polymers resulting from starch or from cellulose; these polymers are modified by grafting acrylonitrile, followed by a hydrolysis. The compositions claimed in this patent application would absorb the water in the stomach with a swelling which may reach 1000 to 2000 times the initial volume, which would result in the death of the animal by bursting of the viscera. The site of swelling targeted by the absorption of such polymers is thus the stomach.

The patent application No. DE 10051065 discloses an inorganic hydrophilic substance, such as calcium sulfate, which is protected by a non-hydrophilic polymer in order to cross the stomach of the rodent as the rodenticidal effect would result from the absorption of the water in the intestines of the animal and not in the stomach.

The patent application No. EP 1 639 893 discloses a substance which is a hydrophilic α-cellulose encapsulated in order to cause it to cross the stomach of the animal. The encapsulating product which protects the α-cellulose from the water is either a non-hydrophilic polymer or an amylase. The encapsulating polymer is destroyed in the intestines and the α-cellulose absorbs the water, which would inhibit ion exchanges in the intestines, resulting in the death of the animal.

Finally, the document BE1000534 A5 describes a composition for the extermination of rodents containing a toxic product registered in Annex 1 of the Biocidal Products Regulation for these animals and a bait, and also particles of a swellable synthetic polymer. It is specified that these swellable polymers may display an obstruction effect additional to the effect of the toxic product itself, and that these particles swell in the stomach.

These existing techniques are not entirely satisfactory as they are very ineffective under real conditions of use. In particular, complex and expensive industrial operations are necessary to protect the active product by encapsulation in order to cause it to pass through the stomach and reach the intestines without being in contact with the stomach fluid.

The result is that, among the documents of the prior art mentioning the use of non-encapsulated polymers, only phenomena of swelling of polymers taking place in the stomach are mentioned. It should furthermore be noted that these phenomena are sometimes described only as producing additional effects with respect to the effect of a toxic rodenticidal product. In other words, there has never been proposed to date means for acting more particularly on the intestines of the rodents to be exterminated by administration of non-encapsulated hydrophilic polymers, this being done up to a lethal dose, and furthermore without joint administration of a supplementary toxic rodenticidal product. Furthermore, the prior art neither describes not suggests that, by adjusting the aqueous absorption capacity of hydrophilic polymers, in particular a maximum aqueous absorption capacity, a lethal activity may be conferred on hydrophilic polymers, by action on the intestines of the rodents to be exterminated.

It is an objective of the present invention to overcome the abovementioned disadvantages by providing an ecological and economic rodenticide which acts on the targeted species and which is not dangerous to man, other animals and the environment.

More specifically, there exists a need to provide hydrophilic polymers or copolymers, in particular not requiring formulation by encapsulation, which are environmentally friendly and which exhibit an absorption capacity adjusted to a lethal activity with regard to rodents to be exterminated, this being more particularly by action on their intestines.

The invention consists of the use of hydrophilic polymers or copolymers of the family of polyacrylic acid or polyacrylate of a monovalent cation, in particular of sodium, crosslinked in proportions of between 50 and 10 000 parts per million, for the manufacture of a rodenticidal product.

Furthermore, a subject matter of the invention is the use of hydrophilic polymers or copolymers of the family of polyacrylic acid or polyacrylate of a monovalent cation, in particular of sodium, crosslinked in proportions of between 50 and 10 000 parts per million, as rodenticidal active substance.

The invention also relates to the use of hydrophilic polymers or copolymers of the family of polyacrylic acid or polyacrylate of a monovalent cation, in particular of sodium, crosslinked in proportions of between 50 and 10 000 parts per million, as rodenticidal active substance intended to bring about a lethal activity on the intestines of the rodent animal, in particular devoid of formulation by encapsulation.

According to a specific embodiment of the invention, the use is devoid of a concomitant use of an additional rodenticidal substance. In other words, according to this embodiment, the hydrophilic polymer or copolymer in accordance with the invention is administered as sole rodenticidal active substance, in particular without formulation by encapsulation.

Thus, the present invention relates in particular to the abovementioned use, wherein the hydrophilic polymers or copolymers are crosslinked sodium polyacrylates, in particular used as only rodenticidal active substance, said polymers or copolymers being more particularly still non-encapsulated.

In the context of the invention, the term “polymer crosslinked in proportions of between x and y ppm” means that a polymer is crosslinked by polymerization in the presence of an amount of crosslinking agent in proportions of between x and y ppm, with respect to the amount of monofunctional monomers. The crosslinking agent may also be used in the same proportions by post-treatment; this agent is conventionally a bifunctional monomer, which precisely makes possible the phenomenon of crosslinking.

The synthetic superabsorbent polymers (SAPs) which may be used in the context of the invention are generally crosslinked polymers or polymers which may be postcrosslinked, such as those described, for example, in the patent application publication No. FR 2 559 158.

Generally, the hydrophilic superabsorbent polymers of synthetic origin sold in the world belong to the families of the polyacrylamides, polyacrylates and acrylate/acrylamide copolymers. They are normally used as hygiene products or for the treatment of water and soils.

These polymers and copolymers may be obtained by any polymerization technique known to a person skilled in the art: solution, emulsion or suspension polymerization, using a crosslinking bifunctional monomer in proportions of between 50 and 10 000 ppm, these polymerizations being followed by a stage which makes it possible to isolate a dry form.

The inventors have demonstrated that, among the three abovementioned families of hydrophilic superabsorbent polymers of synthetic origin, the hydrophilic polymers or copolymers of the family of polyacrylic acid or polyacrylate of monovalent cations, in particular of sodium, which are crosslinked, are particularly suitable for bringing about a lethal activity when they are administered to rodent animals, these acting in particular on their intestines, as is illustrated in the examples below.

Thus, the inventors have observed, contrary to the teaching of the prior art, that polyacrylates of monovalent cations, in particular of sodium, crosslinked in the abovementioned proportions, have the ability to be lethal by oral administration to rodents and may thus be used as rodenticides.

For comparison and illustration of the necessity for the crosslinking, noncrosslinked sodium polyacrylates were tested on male and female rats with oral doses of 0.005, 0.01, 0.025, 0.050 or 0.1 g/kg with a polyacrylate of molar mass 13.10⁶ Da; on a group of four males and four females treated with doses of 0.15 to 1 g/kg, no significant effect was observed after having sacrificed the animals 10 h after treatment; the lethal dose of a 15% sodium polyacrylate solution determined on a group of ten rats was found to be greater than 40 g/kg. The simple hydrophilic property of a polymer is not sufficient to confer rodenticidal properties on it and it was on conclusion of its research studies on the matter that the inventor was able to determine that the use of hydrophilic polymers or copolymers of the family of polyacrylic acid or sodium polyacrylate, crosslinked in proportions of between 50 and 10 000 parts per million, made possible the manufacture of a rodenticidal product.

Thus, the crosslinking, which corresponds to the formation of one or more three-dimensional networks by the presence of bonds between the polymer chains, fully contributes to conferring a lethal nature on the family of polymers and copolymers used in the context of the present invention. It is specified that any type of crosslinking is suitable in the context of the present invention, namely a surface or core crosslinking.

As illustrated in examples 3 and 6 below, the inventors have demonstrated that the nature of the superabsorbent polymer or copolymer is also determining with regard to the lethal activity sought for. Thus, it could be demonstrated that, although the water-absorption capacity of a 30% sodium acrylate and 70% acrylamide copolymer seems to conform to the requirements according to the present invention, the presence of acrylamide monomers in the polymer administered to the rodent animal prevents the targeted objective, namely the death of the animal, from being achieved.

The rodenticidal activity of the hydrophilic polymers or copolymers of the family of polyacrylic acid or polyacrylate of monovalent cations, in particular of sodium, is furthermore related to the amount of water absorbed in the digestive system.

Without the inventors being committed by any theory, it is assumed that water stress takes place after a few days in the intestines of the animals to whom the polymers or copolymers in accordance with the invention have been administered, and that their death is thus brought about. In other words, the mechanism of action of which the inventors take advantage in the context of the present invention is not the obstruction by bulk swelling, bringing about obstruction or bursting of the viscera, nor an action by chemical toxicity, but a sufficiently durable accumulation of an appropriate amount of water in the intestines of the rodent animal. This type of approach had never been envisaged previously, involving a selection of the chemical nature of a hydrophilic polymer and also of its proportion in crosslinking, influencing the aqueous absorption capacity.

Thus, according to a specific embodiment of the invention, the amount of water absorbed by a hydrophilic polymer or copolymer in accordance with the invention, before formulation, is less than 600% and preferably between 100% and 500% by weight, with respect to the total weight of polymers or copolymers.

According to an even more specific embodiment of the invention, the amount of water absorbed before formulation is between 120% and 450% by weight, with respect to the total weight of polymers or copolymers, which corresponds to degrees of crosslinking of between 100 and 6000 ppm.

It is understood that the term “before formulation” means that the absorption of water, in particular of neutral undistilled water, is measured without the polymer or copolymer in accordance with the invention being employed in a dosage formulation favorable to the use targeted according to the present invention.

Another advantage of these crosslinked polymers is that, due to their properties and the specific anatomical features of the targeted rodents, they do not need coating in order to pass through the stomach of the animal as their behavior with regard to water represents a major role: this is because, in the highly acidic stomach medium, the polymer absorbs little water, does not swell to a great extent and can thus reach the intestines in which the change in pH makes possible a greater affinity with water.

It could thus be observed that, in the presence of the mean pH of the stomach medium of a rodent, the absorption of water by the rodenticidal product obtained was between 10% and 30% and that, in the presence of the mean pH of the intestinal medium of a rodent, the absorption of water by the rodenticidal active substance obtained was between 50% and 100%.

It could also be observed, as is illustrated in particular in examples 1 and 2, that, in the presence of the mean pH of the stomach medium of a rodent, the absorption of water by the hydrophilic polymer or copolymer in accordance with the invention was between 10% and 30% and that, in the presence of the mean pH of the intestinal medium of a rodent, the absorption of water by the hydrophilic polymer or copolymer in accordance with the invention was between 50% and 100%.

The mean pH, of the stomach or intestines, is understood as being a mean pH, of the stomach or intestines, between the species of harmful rodents which the present invention is targeted at exterminating.

It is thus apparent that an absorption capacity of the polymers and copolymers in accordance with the invention which is much less than that which appears targeted, for example, for polymers of another nature in the document of the prior art JPH 02304007 mentioned in the preamble is of use for achieving the lethal activity sought for.

The products of Aprotek in France or any commercial product which may be used for the production of hygiene articles or articles for the treatment of water and soils are capable of being used for the manufacture of the rodenticidal product according to the invention.

According to a specific embodiment, crosslinked sodium polyacrylates are used. Mention may in particular be made, among the hydrophilic polymers or copolymers of the family of polyacrylic acid or polyacrylate of monovalent cations, in particular of sodium, which are suitable for the implementation of the invention, of the crosslinked sodium polyacrylates sold by Aprotek, in particular sold under the names PXL 150 or G300.

Mention may be made, as monovalent cation, of any monovalent metal cation, in particular alkali metals, such as sodium or potassium.

According to a specific embodiment, the degrees of crosslinking of the polymers or copolymers in accordance with the invention are between 100 ppm and 6000 ppm. These degrees of crosslinking are achieved by use of a bifunctional monomer in proportions of between 100 and 6000 ppm.

According to yet another specific embodiment, the hydrophilic polymers or copolymers of the family of polyacrylic acid or polyacrylate of monovalent cation, in particular of sodium, are crosslinked in proportions of less than 1500 ppm, in particular in proportions of between 200 and 1500 ppm.

By way of example, the polymers sold by Aprotek, in particular sold under the names PXL 150 or G300, are both crosslinked in proportions of 600 ppm. The 150XL is crosslinked at the surface and the G300 is crosslinked during the polymerization, which explains the differences in water-absorbing capacity despite one and the same degree of crosslinking.

According to a specific embodiment of the invention, the polymers or copolymers in accordance with the invention may be provided in the form of powders or granules. The mean dimension of this powder or of these grains may advantageously be less than 1 mm. Thus, according to a specific embodiment of the invention, the powders or granules of polymers or copolymers in accordance with the invention may exhibit a mean dimension of between 0.2 and 1 mm, in particular between 0.3 and 0.8 mm.

In the case of the product sold by Aprotex under the name 150XL, the size of the grains is less than 350 micrometers and, in the case of the product sold by Aprotex under the name G300, the size of the grains is less than 750 micrometers.

Another subject matter of the present invention is the use in accordance with the invention, wherein the hydrophilic polymers or copolymers are formulated in rodenticidal products, preferably devoid of additional rodenticidal substance, and also in particular devoid of a formulation by encapsulation, exhibiting an appetizing coating according to respective proportions of 1% to 50% by weight of polymer or copolymer and of 99% to 50% by weight of appetizing coating, with respect to the total weight of the rodenticidal products.

Another subject matter of the present invention is a rodenticidal product, characterized in that it comprises at least one polymer or copolymer in accordance with the invention and also at least one appetizing product which may be chosen from cereals, vegetable oils, paraffin and their mixtures.

Consequently, the invention extends to a rodenticidal product composed of polymers or copolymers as mentioned above and of an appetizing coating according to respective proportions of 1% to 50% by weight of polymer or copolymer and of 99% to 50% by weight of appetizing coating, and preferably between 5% and 40% by weight of polymers or copolymers and between 95% and 60% by weight of appetizing coating, with respect to the total weight of rodenticidal product.

By virtue of this appetizing coating, the targeted animal is attracted and ingests the rodenticide. The latter passes through the stomach, while absorbing little water, and ends up in the intestines, bringing about the death of the animal in a few days.

The appetizing coating may in particular consist based on cereals and vegetable oil or paraffin, and may comprise any product participating in the composition of a rodenticide.

The rodenticidal product may be provided in the form of granules, of pastes, of a block or be as a mixture with cereals.

The rodenticidal product may be obtained by a process which comprises the stages consisting in mixing the abovementioned polymers or copolymers with an appetizing product, in order to form a paste, and in then using an extruder to shape the product.

The present invention extends to a process for the manufacture of a rodenticidal product, characterized in that it comprises the stages consisting in mixing the polymers or copolymers in accordance with the invention with an appetizing product, in order to form a paste, and in then shaping the paste thus obtained, optionally using an extruder.

Another subject matter of the present invention is a rodenticidal product obtained by the manufacturing process according to the present invention.

The examples and tables below illustrate the invention.

### EXAMPLE NO. 1

The behavior of a polymer A (reference: PXL 150 from Aprotek) in water, the stomach medium and the intestinal medium

1 g of polymer and 1000 g of liquid water (composition corresponding to the stomach fluid, composition corresponding to the intestinal fluid) are introduced into a beaker. Filtration is carried out at equilibrium, the filtrate is then weighed and the amount of liquid absorbed by the polymer is deduced therefrom. The operation is repeated three times at 25 and 40° C.:

| P150 XL | Water | Gastric medium | Intestinal medium |
|---|---|---|---|
| Weight absorbed % | 145-148. | 20 | 60 |

### EXAMPLE NO. 2

The behavior of the polymer B (reference G300 from Aprotek) in water, the stomach medium and the intestinal medium.

The absorption of the polymer B is determined under the same conditions as those described in example 1:

| G300 | Water | Gastric medium | Intestinal medium |
|---|---|---|---|
| Weight absorbed % | 400 | 20 | 93 |

### EXAMPLE NO. 3 (COMPARATIVE)

The behavior of a polymer C (reference: Aprodev mean of the grains less than 3000 μm)

| Aprodev06 | Water | Gastric medium | Intestinal medium |
|---|---|---|---|
| Weight absorbed % | 300 | 30 | 50 |

### EXAMPLE NO. 4

Preparation of an appetizing formula with the Polymer A

12 g of sugar (Daddy® brand), 0.24 g of cooking salt (fine salt, Cérébos® brand), 145 g of wheat flour (T45 fluid, Sonnen Gold® brand) and 22.8 g of almond powder (powdered almond, Vahiné® brand) are added to and mixed with 450 g of superabsorbent polymer (reference P150XL from Aprotek) in order to obtain a homogeneous mixture of powders. Subsequently, 270 g of rapeseed oil (Aurea brand) are added to this mixture with stirring. Finally, this mixture is kneaded until a homogeneous product is obtained.

### EXAMPLE NO. 5

Preparation of appetizing formula with the Polymer B

8 g of sugar (Daddy® brand), 0.16 g of cooking salt (fine salt, Cérébos® brand), 97 g of wheat flour (T45 fluid, Sonnen Gold® brand) and 15.2 g of almond powder (powdered almond, Vahiné® brand) are added to and mixed with 300 g of superabsorbent polymer (reference G300 from Aprotek) in order to obtain a homogeneous powder. Subsequently, 180 g of rapeseed oil (Aurea brand) are added and this mixture is kneaded until a homogeneous product is obtained.

The results of the consumption of a rodenticidal product in accordance with the invention by brown rats are presented in table 1 below; and

The results of the consumption of a rodenticidal product in accordance with the invention by mice are presented in table 2 below.

The consumption of the polymer A is lethal from the fourth day. The consumption of the polymer B is also lethal but with an effect from the sixth day.

### EXAMPLE NO. 6 (COMPARATIVE)

Preparation of appetizing formula with the polymer C of comparative example 3

8 g of sugar (Daddy® brand), 0.16 g of cooking salt (fine salt, Cérébos® brand), 97 g of wheat flour (T45 fluid, Sonnen Gold® brand) and 15.2 g of almond powder (powdered almond, Vahiné® brand) are added to and mixed with 350 g of superabsorbent polymer (reference Aprodev 06 from Aprotek) in order to obtain a homogeneous powder. Subsequently, 180 g of rapeseed oil (Aurea brand) are added and this mixture is kneaded until a homogeneous product is obtained.

The results of the consumption of a comparative rodenticidal product by mice are presented in table 3 below.

TABLE 3

| BROWN RATS | | | |
|---|---|---|---|
| (Rattus norvegicus) | | | |
| The product was tested | | MICE (Mus musculus domesticus) | |
| on 5 animals and a | | Each product was tested on | |
| mean of the consumption | | 5 animals. The consumption | |
| was produced and | | shown is that of 5 animals | |
| was relative to/rat unit. | | without food competition. | |
| | Consu 50% | | Consu 50% |
| Day | Aprodev06/rat unit | Day | Aprodev06/unit of 5 mice |
| D1 | 1.3 | D1 | 2.4 |
| D2 | 2.6 | D2 | 4.8 |
| D3 | 3.2 | D3 | 5.6 |
| D4 | 3.4 | D4 | 6.1 |
| D5 | 1.2 | D5 | 4.3 |
| D6 | 1.1 | D6 | 4.2 |

For both types of animals, no mortality was observed. This example has demonstrated the ineffectiveness of a formulation prepared with Aprodev 06.

1-13. (canceled)

14. A method of controlling rodent populations comprising administering a rodenticidal active substance to rodent(s), wherein the rodenticidal active substance comprises hydrophilic polymers or copolymers of polyacrylic acid or polyacrylate of monovalent cation, crosslinked in proportions of between 50 and 10,000 parts per million.

15. The method of claim 14, wherein the monovalent cation is present and is a sodium cation.

16. The method of claim 14, wherein, in a presence of a mean pH of a rodent stomach medium, water absorption by said rodenticidal active substance is between 10% and 30% and wherein, in a presence of a mean pH of a rodent intestinal medium, water absorption by said rodenticidal active substance is between 50% and 100% thereby reducing rodent mortality.

17. The method of claim 14, wherein the hydrophilic polymers or copolymers are crosslinked sodium polyacrylates.

18. The method of claim 14, wherein the hydrophilic polymers or copolymers of polyacrylic acid or polyacrylate of monovalent cation is the only rodenticidal active substance.

19. The method of claim 14, wherein said polymers or copolymers are non-encapsulated.

20. The method of claim 14, wherein the polymers or copolymers are crosslinked between 100 ppm and 6000 ppm.

21. The method of claim 14, wherein the polymers or copolymers are crosslinked between 200 and 1500 ppm.

22. The method of claim 14, wherein the rodenticidal active substance is in a rodenticidal product, the rodenticidal product having an appetizing coating that coats the rodenticidal active substance and having respective proportions of 1% to 50% by weight of the rodenticidal active substance and of 50% to 99% by weight of the appetizing coating, with respect to total weight of the rodenticidal product.

23. The method of claim 22, wherein the rodenticidal products are devoid of additional rodenticidal active substance(s).

24. The method of claim 14, wherein the rodenticidal active substance is formulated in a rodenticidal product, the rodenticidal product having an appetizing coating that coats the rodenticidal active substance and having respective proportions ranging from 5% to 40% by weight of the rodenticidal active substance and ranging from 60% to 95% by weight, with respect to total weight of the rodenticidal product.

25. The method of claim 24, wherein the rodenticidal product is devoid of additional rodenticidal active substance(s).

26. The method of claim 22, wherein the appetizing coating consists of cereals and vegetable oil or paraffin.

27. The method of claim 22, wherein the rodenticidal product is provided as granules, of pastes, of blocks or of a mixture with cereals.

28. The method of claim 24, wherein the appetizing coating consists of cereals and vegetable oil or paraffin.

29. The method of claim 24, wherein the rodenticidal product is provided as granules, of pastes, of blocks or of a mixture with cereals.

30. A process for manufacturing a rodenticidal product, comprising mixing a rodenticidal active substance with an appetizing product to form a paste, and subsequently shaping the paste, wherein:
the rodentcidal active substance comprises polymers or copolymers of polyacrylic acid or polyacrylate of monovalent cation, crosslinked in proportions of between 50 and 10,000 parts per million.

31. A rodenticidal product comprising at least one hydrophilic polymer or copolymer of polyacrylic acid or polyacrylate of monovalent cation and at least one appetizing product chosen from cereals, vegetable oils, paraffin, and mixtures thereof.

32. The rodenticidal product of claim 31, wherein the rodenticidal product is composed of polymers or copolymers that are hydrophilic polymers or copolymers of polyacrylic acid or polyacrylate of monovalent cation, crosslinked in proportions of between 50 and 10 000 parts per million,
and an appetizing coating, the rodenticidal product having respective proportions ranging between 1% and 50% by weight of the polymer or copolymer and between 50% and 99% by weight of appetizing coating, with respect to the total weight of rodenticidal product.

33. The rodenticidal product of claim 31, wherein the rodenticidal product is composed of polymers or copolymers that are hydrophilic polymers or copolymers of polyacrylic acid or polyacrylate of monovalent cation, crosslinked in proportions of between 50 and 10 000 parts per million, and an appetizing coating, the rodenticidal product having respective proportions between 5% and 40% by weight of the polymer or copolymer and between 60% and 95% by weight of appetizing coating, with respect to the total weight of rodenticidal product.
